(19) United States
(12) Patent Application Publication
(10) Pub. No.: US 2013/0007045 A1
(43) Pub. Date: Jan. 3, 2013

(54) SYSTEM, METHOD AND COMPUTER PROGRAM PRODUCT FOR LINKING CONTENT AVAILABILITY TO MEDIA CONSUMPTION

(76) Inventors: John W. Carroll, Gilbert, AZ (US); Mariano J. Phielipp, Mesa, AZ (US)

(21) Appl. No.: 13/175,186

(22) Filed: Jul. 1, 2011

(51) Int. Cl. G06F 17/30

(52) U.S. Cl. 707/769; 707/E17.014

(57) ABSTRACT

The systems, methods and computer program products described herein may allow a user to view a desired content item, on the condition that the user has viewed other content that the content provider defines as a prerequisite content item. When a user views content, this fact may be recorded in the viewing history data structure associated with the user. If the user wishes to see a content item that has a prerequisite content item, the content provider may scan the viewing history to see whether or not the user has seen the prerequisite content item. If so, then the requested content item may be provided to the user.

### BACKGROUND

The business models used by multimedia content providers often encourage the presentation of certain content to users. Such content may include, for example, advertising. This provides a way to monetize the presentation of media. In another example, a content provider may encourage viewing of media that the provider wishes to publicize. This may include, for example, a television program for which the provider wishes to build viewership. In either case, the content provider has a strong preference, if not a requirement, that a user be exposed to certain specific content.

This preference on the part of a content provider may be so strong that other content may be blocked by the provider. In this way, a content provider may hope to encourage the user to view the preferred media, e.g., advertising content, or other content that includes such advertisements. For example, a user may be blocked from viewing a commercial free version of an old television program, but may be allowed by the content provider to view a version that includes commercials. The problem with such a strategy is that such blockage is not done in an informed manner. A viewer may well have seen the television program, including all of its commercials, the previous evening. But now, on the following evening, the viewer may hope to see a commercial free version. Under current practice, the user may be blocked from seeing the commercial free version when in fact the user has already seen all of the advertising that the content provider hoped he would see.

In such a situation, the user may be prevented from seeing desired content, even though he has satisfied the requirements of the provider, e.g., the user has seen all the advertising. This obviously frustrates the user, and potentially damages the relationship between the user and the provider.

### BRIEF DESCRIPTION OF THE DRAWINGS/FIGURES

FIG. 1 is a block diagram generally illustrating the operation of the systems, methods, and computer program products described herein, according to an embodiment.

FIG. 2 is a flow chart illustrating the processing at a content provider, according to an embodiment.

FIG. 3 is a flow chart illustrating the determination of whether a prerequisite content item needs to have been viewed by a user, according to an embodiment.

FIG. 4 is a flow chart illustrating the updating of a user's viewing history, according to an embodiment.

FIG. 5 is a block diagram illustrating a computing environment of the systems, methods, and computer program products described herein, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

The systems, methods and computer program products described herein may allow a user to view a desired content item, on the condition that the user has viewed other content that the content provider defines as a prerequisite content item. When a user views content, this fact may be recorded in a viewing history data structure associated with the user. If the user wishes to see a content item that has an associated prerequisite content item, the content provider may scan the viewing history to see whether or not the user has seen the prerequisite content item. If so, then the requested content item may be provided to the user.

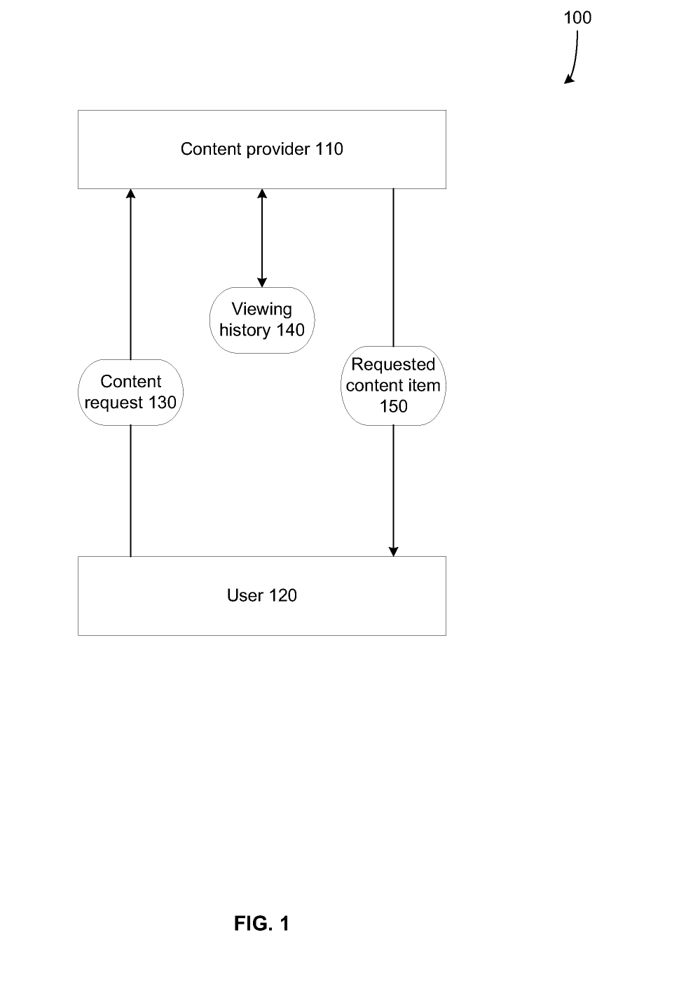

An overall illustration of the systems and methods described herein is provided in FIG. 1, according to an embodiment. Content provider 110 may be any system that distributes content from one or more content storage devices upon request, such as a news or entertainment outlet and its accompanying infrastructure. Examples may include commercial broadcasters, such as NBC and BBC, and cable providers such as ESPN and HBO. It is to be understood that these content providers are provided as illustrations and are not meant to be limiting. The user 120 may be a viewer at home or elsewhere, seeking to access content through a television, personal computer, tablet, smart phone, or other media consumption device.

User 120 may first present a content request 130 to content provider 110. The content request 130 may reference a specific content item that user 120 wishes to see. The identified content item may be, for example, a particular news documentary, a recording of a particular sports event, or a particular episode of the television program. After receiving the content request 130, the content provider 110 may determine whether the user 120 needs to have seen a prerequisite content item before being allowed access to the requested content item. Such a prerequisite content item may be predetermined by the content provider 100 and with respect to the requested content item. For example, if the user 120 wishes to see a commercial free version of a documentary, the content provider 110 may require that the user 120 first see a version of the documentary that contains particular advertising. In this case, the version of the documentary containing this advertising may represent the prerequisite content item. In another example, the content provider 110 may first require that user 120 watch a television program that content provider 110 wishes to publicize. In this case, this television program would represent the prerequisite content item.

If it is determined by a content provider 110 that the user 120 needs to have first seen the prerequisite content item before being allowed to view the requested content item, then the content provider 110 may access a viewing history 140 that corresponds to the user 120. In this embodiment, viewing history 140 may include a data structure that lists indications of content items that user 120 have previously viewed. In an embodiment, an individual content item may include data that characterizes or identifies the content item. Such data may include, for example, identifying metadata, a digital watermark, or some other form of content fingerprint. This characterizing data or some function thereof may be used to identify content that the user 120 has already seen, for purposes of including a reference to the viewed content in viewing history 140. If the viewing history 140 shows that the user 120 has already seen the prerequisite content item for the requested content, then the requested content item, shown here as content item 150, may be provided to the user 120. In an embodiment, content may be distributed by a content server operated by the content provider 110.

The illustrated communications between the user 120 and the content provider 110 may take place using any network or media known to persons of ordinary skill in the art. These communications may take place over wireless or wired media (including optical fiber), a local or wide area network, the Internet, or any combination thereof.

In an alternative embodiment, the requested content item may be available locally from a digital video recorder (DVR) or one or more other local content storage devices. In such an embodiment, the logic described above may be executed locally. The local storage device or other local computing platform may determine if a requested content item has an associated prerequisite content item. If so, such a local device may consult the user's viewing history (which may be stored locally in such an embodiment) and determine if the user has seen the prerequisite content item. If so, the local device may then permit access to the requested content item. In an embodiment, such a local device may be a set-top box (STB), a DVR, or other local computing platform. In such an embodiment, the locally stored viewing history may include content items provided by multiple content providers.

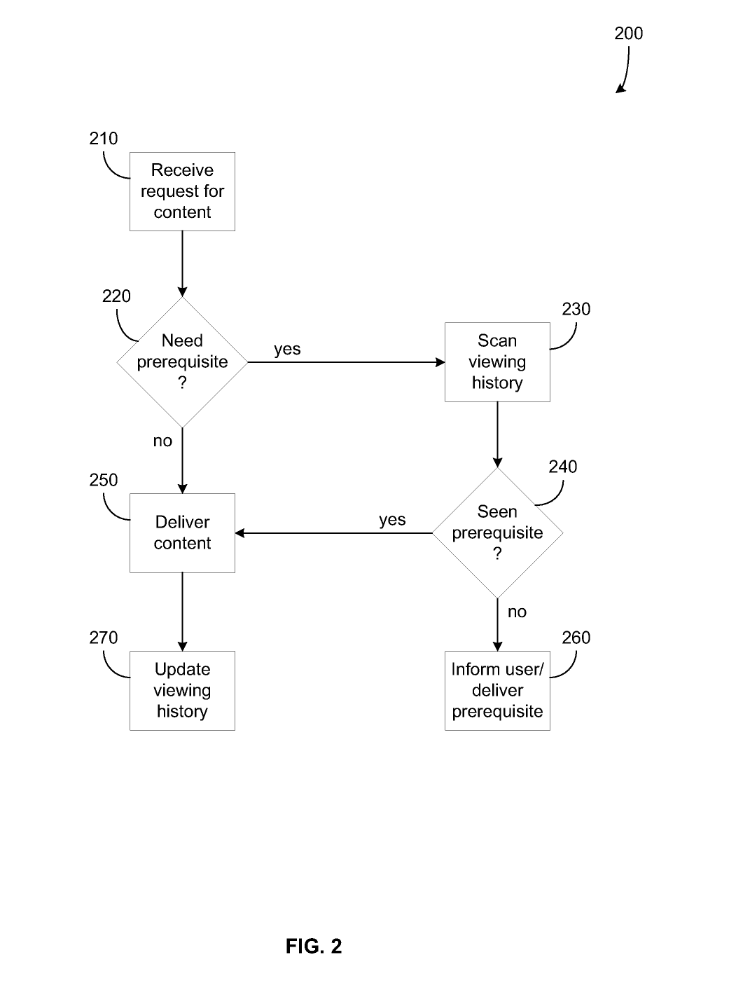

The operation of the systems, methods, and computer program products described herein is illustrated in FIG. 2, according to an embodiment. At 210, a request for a content item may be received. Such a request may be received at a content provider, or may be received locally at a device from which content may be accessed. At 220, the determination may be made as to whether the requested content item has an associated prerequisite content item. If so, then at 230 the viewing history of the requesting user may be scanned. At 240, it may be determined whether the user has seen the prerequisite content item, as revealed in the viewing history. If so, then the requested content may be delivered at 250. If the viewing history shows that the prerequisite has not been seen by the user, then at 260 the user may be so informed. In an embodiment, the prerequisite content item may be delivered to the user at this point. Alternatively, the information sent to the user at this point may include a specific reference to the prerequisite content item that the user must see before being allowed access to the requested content item.

If it is determined that 220 that no prerequisite content item exists for the requested content item, then at 250 the requested content item may be presented to the user.

In an embodiment, the viewing history of the user may be updated after every delivery of a content item. This is shown at 270, where the viewing history may be updated to reflect the fact that the user has now seen the requested content item.

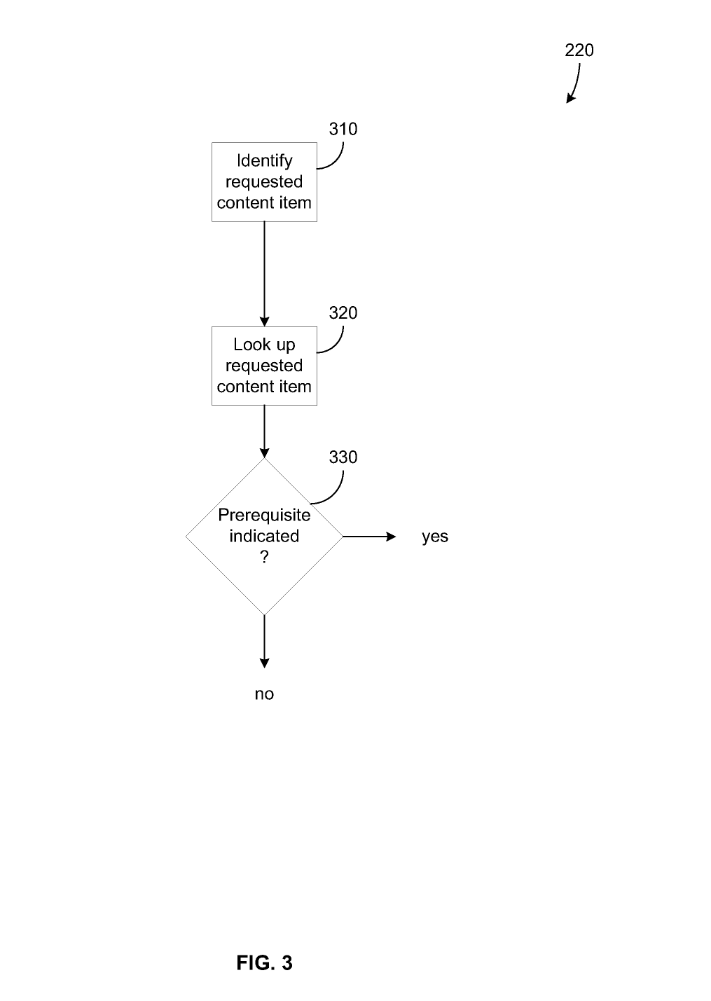

The determination at 220 as to whether a requested content item has an associated prerequisite content item is illustrated in greater detail in FIG. 3, according to an embodiment. At 310, the requested content item may be identified. At 320, the requested content item may be looked up in a data structure that associates the prerequisite content items with requested content items. As would be understood by a person of ordinary skill in the art, such a data structure may be a database, a lookup table, or other similar data structure for example. At 330 it may be determined whether a prerequisite content item is indicated for the requested content item.

Note that in alternative embodiments, a requested content item may have more than one prerequisite content item indicated at 330. In such an embodiment, the set of prerequisite content items would be associated with the requested content item, and the user may have to all prerequisites (as determined at 230 and 240) before being granted access to the requested content item. If one or more prerequisite content items have not yet been viewed, then the user may be informed of this at 260. In an alternative embodiment, if there are multiple prerequisite content items associated with a requested content item, it may be that the user is required to have viewed one of the prerequisites, i.e., the set of prerequisite content items may be alternative prerequisites, where the user needs to have seen prerequisite A or B. In this case, it would be sufficient, at 240, for the user to have viewed one of the prerequisite content items.

In an alternative embodiment, the prerequisite content items may be sequenced. In this case, the user may have to view prerequisite content item A, followed by prerequisite content item B, before being allowed to view requested content item C for example. If the user has not yet viewed all of the sequenced prerequisite content items, this may be determined at 230 and 240, and he may be so informed at 260.

In an embodiment, a prerequisite content item may have associated conditions that must be satisfied before the user is allowed to view the requested content item. For example, the prerequisite content item may have to be viewed from a particular content provider or broadcast network. Prerequisite content item A may have to have been viewed on CBS, for example. If the prerequisite was viewed on a different network, e.g., NBC, this may be reflected in the viewing history; it may then be determined at 240 that the prerequisite, the content item A on CBS, was not seen. Moreover, there may be a time restriction included. A prerequisite content item may have to be viewed within the past 30 days, for example. If the prerequisite content item has been viewed 31 days ago or more, then this fact may be reflected in the viewing history as scanned at 230. At 240 it may then be determined that this prerequisite content item was not timely viewed.

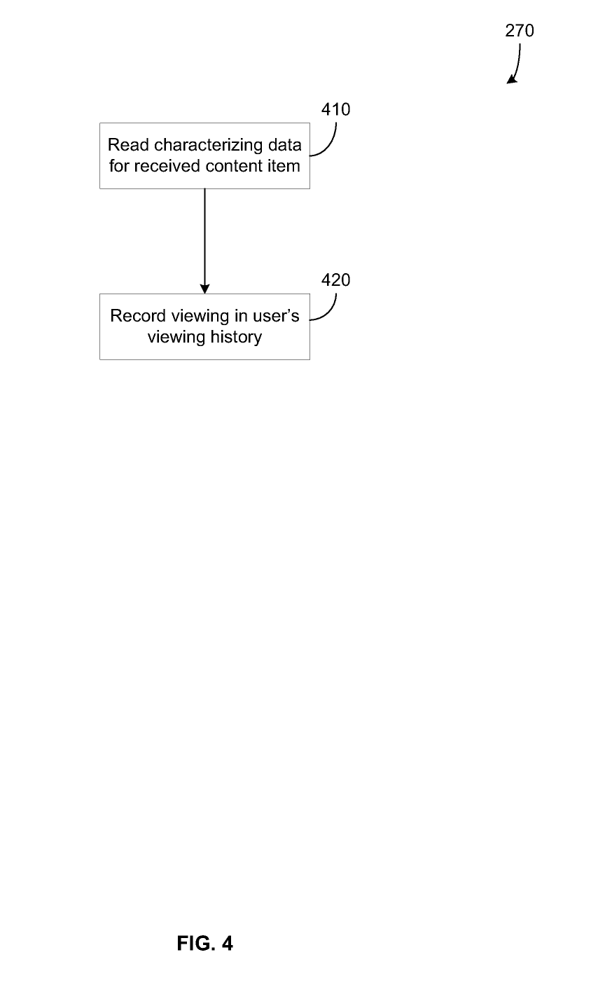

The updating of the users viewing history (270 in FIG. 2) is illustrated in greater detail in FIG. 4, according to an embodiment. At 410, the characterizing data of the received content item may be read. As discussed above, the characterizing data may be included in metadata of the received content, and may be a digital watermark or other content fingerprint. At 420, the fact that the user has viewed the received content item may be recorded in the viewing history of the user.

In an embodiment, the viewing history may include information identifying viewed content items. This information may also include related data, such as the content provider from which the content item was accessed. This may be useful if, for example, a prerequisite content item needs to have been viewed from a particular provider, as discussed above. The time or date at which a content item was viewed may also be included in the viewing history. This may be useful in embodiments where a prerequisite content item needs to have been viewed relatively recently before the requested content item can be provided. The viewing history may therefore include a timestamp for each viewed item, indicating when the content item was viewed or delivered, and/or an indication as to when the prerequisite content needs to have been viewed. In an embodiment, content items that were viewed a sufficiently long time ago by the user may be purged from the viewing history. If a prerequisite content item needs to have been viewed within 30 days, for example, this content item may be purged on the 31^{st} day after viewing. From that point forward, a scan of the viewing history would not see this prerequisite content item, and at 240 it would be determined that the prerequisite content item had not been viewed. This would force the user to view the prerequisite content item again before being allowed to view requested content. The threshold time interval after which a content item may be purged from the viewing history may be determined by the content provider, and may vary per prerequisite content item.

In an embodiment, the viewing history may include content items viewed from more than one content providers or services, and may include content viewed using more than one user account.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, or other data storage device.

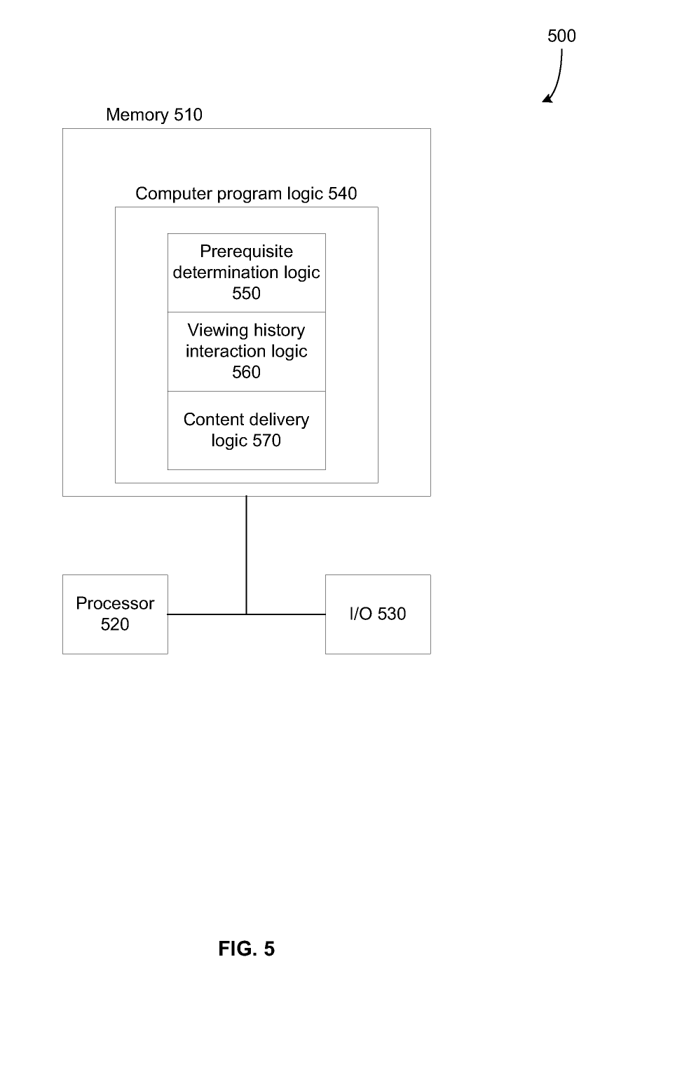

FIG. 5 illustrates a software or firmware embodiment of the processing described herein. In an embodiment, the system 500 may be implemented at content provider 110. System 500 may include a processor 520 and may further include a body of memory 510. Memory 510 may include one or more computer readable media that may store computer program logic 540. Memory 510 may be implemented as a hard disk and drive, a removable media such as a compact disk, a read-only memory (ROM) or random access memory (RAM) device, for example, or some combination thereof. Processor 520 and memory 510 may be in communication using any of several technologies known to one of ordinary skill in the art, such as a bus. Computer program logic 540 contained in memory 510 may be read and executed by processor 520. One or more I/O ports and/or I/O devices, shown collectively as I/O 530, may also be connected to processor 520 and memory 510.

Computer program logic 540 may include prerequisite determination logic 550. This module may be responsible for determining whether a requested content item has an associated perquisite content item, as described above. Computer program logic 540 may also include viewing history interaction logic 560. This module may be responsible for querying the viewing history of a user to determine whether the user has seen a prerequisite content item. This module may also be responsible for updating the viewing history after a content item has been delivered to the user. Computer program logic 540 may also include content delivery logic 570. In an embodiment, this module may be responsible for delivering requested content to the user, or preventing delivery if the user has not seen a prerequisite content item.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
after receiving a request from a user for a first content item, determining if viewing the first content item requires the user to have a viewed a prerequisite content item;
if so, determining if the user has viewed the prerequisite content item; and
delivering the first content item from a content storage device to the user if the user has viewed the prerequisite content item.

2. The method of claim 1, wherein said determining if the user has viewed the prerequisite content item comprises:
determining if the prerequisite content item is identified in a viewing history of the user.

3. The method of claim 2, wherein the prerequisite content item is identified, for purposes of inclusion in the users viewing history, by data characteristic of the prerequisite content item.

4. The method of claim 3, wherein the data characteristic of the prerequisite content item comprises a digital watermark.

5. The method of claim 3, wherein the data characteristic of the prerequisite content item comprises a content fingerprint.

6. The method of claim 1, further comprising:
updating a viewing history of the user after delivery of the first content item to the user, indicating the user's viewing of the first content item.

7. The method of claim 1, wherein the prerequisite content item includes advertising content.

8. A system, comprising:
a processor; and
a memory device in communication with said processor, wherein said memory stores a plurality of processing instructions configured to direct said processor to
determine, after receiving a request from a user for a first content item, if viewing the first content item requires the user to have a viewed a prerequisite content item;
if so, determine if the user has viewed the prerequisite content item; and
deliver the first content item from a content storage device to the user if the user has viewed the prerequisite content item.

9. The system of claim 8, wherein said processing instructions configured to direct said processor to determine if the user has viewed the prerequisite content item comprises:
processing instructions configured to direct said processor to determine if the prerequisite content item is identified in a viewing history of the user.

10. The system of claim 9, wherein the prerequisite content item is identified, for purposes of inclusion in the users viewing history, by data characteristic of the prerequisite content item.

11. The system of claim 10, wherein the data characteristic of the prerequisite content item comprises a digital watermark.

12. The system of claim 10, wherein the data characteristic of the prerequisite content item comprises a content fingerprint.

13. The system of claim 8, wherein said processing instructions further comprise:
processing instructions configured to direct said processor to update a viewing history of the user after delivery of the first content item to the user, indicating the user's viewing of the first content item.

14. The system of claim 8, wherein the prerequisite content item includes advertising content.

15. A computer program product including a non-transitory computer readable medium having computer program logic stored therein, the computer program logic comprising:
logic to cause a processor to determine, after receiving a request from a user for a first content item, if viewing the first content item requires the user to have a viewed a prerequisite content item;
logic to cause the processor to determine if the user has viewed the prerequisite content item if viewing the first content item requires the user to have a viewed the prerequisite content item; and
logic to cause the processor to deliver the first content item from a content storage device to the user if the user has viewed the prerequisite content item.

16. The computer program product of claim 15, wherein said logic to cause the processor to determine if the user has viewed the prerequisite content item comprises:
logic to cause the processor to determine if the prerequisite content item is identified in a viewing history of the user.

17. The computer program product of claim 16, wherein the prerequisite content item is identified, for purposes of inclusion in the users viewing history, by data characteristic of the prerequisite content item.

18. The computer program product of claim 17, wherein the data comprises at least one of a digital watermark and a content fingerprint.

19. The computer program product of claim 15, further comprising:
logic to cause the processor to update a viewing history of the user after delivery of the first content item to the user, indicating the user's viewing of the first content item.

20. The computer program product of claim 15, wherein the prerequisite content item includes advertising content.
